(19) United States
(12) Patent Application Publication
(10) Pub. No.: US 2022/0358545 A1
(43) Pub. Date: Nov. 10, 2022

(54) Electronic Device for Providing User Activity Information in a Platform and Method Thereof

(71) Applicant: Coupang Corp., Seoul (KR)

(72) Inventors: Jin Young Choi, Seoul (KR); Myoung Ho Park, Seoul (KR); Hyung Won Jeon, Seoul (KR); Hyung Gu Kim, Seoul (KR); Ah Ram Son, Seoul (KR)

(73) Assignee: Coupang Corp., Seoul (KR)

(21) Appl. No.: 17/394,034

(22) Filed: Aug. 4, 2021

(30) Foreign Application Priority Data
May 4, 2021 (KR) 10-2021-0057831

(51) Int. Cl. G06Q 30/02; G06F 16/903; G06F 16/907

(52) U.S. Cl. CPC G06Q 30/0267; G06F 16/90335; G06F 16/907; G06Q 30/0269

(57) ABSTRACT

Provided is a method of providing information by an electronic device according to various example embodiments of the present disclosure. The method includes acquiring information on an action of at least one user terminal that accesses a platform, confirming activity information of at least one user on the basis of the information on the action, receiving request information including a preset condition from at least one external device, confirming at least one piece of first activity information corresponding to the preset condition among the activity information of the at least one user, and transmitting the at least one piece of first activity information to the at least one external device.

### TECHNICAL FIELD

Example embodiments of the present disclosure relate to an electronic device for providing activity information of a user in a platform and a method thereof.

### DESCRIPTION OF THE RELATED ART

Users who purchase items being sold through electronic commerce or e-commerce are diversifying due to the activation of the non-contact market. A user may perform activities of searching for an item desired to purchase, accessing a page for purchase, and leaving a purchase review for a purchased item in a platform.

In a situation where information related to user activities performed in the platform is vast, there is a need to more effectively utilize the user activity-related information.

As a reference document, there is Korean Patent Publication No. 10-2018-0043671.

### DISCLOSURE OF THE INVENTION

An aspect provides an electronic device for confirming user activity information in a platform and providing information matching information required by an external device that wants to place an advertisement to the external device, and a method thereof.

However, technical goals to be achieved by these example embodiments are not limited to the aforementioned technical goals, and other technical goals may be inferred from the following example embodiments.

According to an aspect, a method of providing information by an electronic device includes acquiring information on an action of at least one user terminal that accesses a platform, confirming activity information of at least one user on the basis of the information on the action, receiving request information including a preset condition from at least one external device, confirming at least one piece of first activity information corresponding to the preset condition among the activity information of the at least one user, and transmitting the at least one piece of first activity information to the at least one external device.

According to another aspect, an electronic device for providing information includes a processor configured to acquire information on an action of at least one user terminal that accesses a platform, confirm activity information of at least one user on the basis of the information on the action, receive request information including a preset condition from at least one external device, confirm at least one piece of first activity information corresponding to the preset condition among the activity information of the at least one user, and transmit the at least one piece of first activity information to the at least one external device.

According to another aspect, a non-transitory computer-readable storage medium includes a medium configured to store computer-readable instructions. When the computer-readable instructions are executed by a processor, the processor performs an information provision method including acquiring information on an action of at least one user terminal that accesses a platform, confirming activity information of at least one user on the basis of the information on the action, receiving request information including a preset condition from at least one external device, confirming at least one piece of first activity information corresponding to the preset condition among the activity information of the at least one user, and transmitting the at least one piece of first activity information to the at least one external device.

According to various example embodiments of the present disclosure, an electronic device may confirm user activity information in a platform, confirm activity information matching a preset condition of request information received from an external device as first activity information, and provide the confirmed first activity information to the external device, and thus it is possible to provide a more effective advertisement in the external device.

According to various example embodiments of the present disclosure, an information provision method may include an approval process of confirming activity information matching a changed preset condition as second activity information when the preset condition is changed in response to request information of an external device changed in real time and transmitting the second activity information corresponding to added request information to the external device without transmitting information excluded from the request information due to the change in first activity information, and thus it is possible to adaptively transmit activity information.

Effects of the present disclosure are not limited to the aforementioned effects, and other effects which are not mentioned here can be clearly understood by those skilled in the art from the appended claims.

### BRIEF DESCRIPTION OF THE DRAWINGS

FIG. 1 is a block diagram showing elements of an electronic device according to various example embodiments of the present disclosure.

FIG. 2 is a schematic flowchart of an information provision method according to various example embodiments of the present disclosure.

FIG. 3 is a flowchart related to the provision of information between an electronic device and an external device according to various example embodiments of the present disclosure.

FIG. 4 is a flowchart illustrating approval related to the provision of information from an electronic device to an external device according to various example embodiments of the present disclosure.

FIG. 5 is an exemplary diagram related to information stored in an electronic device according to various example embodiments of the present disclosure.

FIG. 6 is an exemplary diagram related to detailed information transmitted to an external device among information stored in an electronic device according to various example embodiments of the present disclosure.

FIG. 7 is an exemplary diagram related to information provided from an electronic device to an external device according to various example embodiments of the present disclosure.

### DETAILED DESCRIPTION OF THE INVENTION

Terms used herein have been selected as general terms which are widely used at present in consideration of the functions of the present disclosure but may be altered according to the intent of an operator skilled in the art, conventional practice, or introduction of new technology. In addition, specific terms have been arbitrarily selected by the applicant and their meanings will be described in detail in the corresponding sections. Therefore, the terms used herein should be defined on the basis of the overall content of the present disclosure instead of simply the names of the terms.

Throughout the specification, when a part is referred to as including a certain element, this means that the part may include other elements rather than excluding other elements unless otherwise stated. Also, terms such as “-er,” “-or,” and “module” used herein refer to an element for performing at least one function or operation and may be implemented with hardware, software, or a combination thereof.

An expression “at least one of a, b, and c” used herein may encompass “only a,” “only b,” “only c,” “a and b,” “a and c,” “b and c,” or “all of a, b, and c.”

The term “terminal” mentioned below may be implemented as a computer or portable terminal that can access a server or another terminal over a network. Here, a computer may include, for example, a notebook, a desktop, a laptop, and the like which are equipped with a web browser, and a portable terminal may be, for example, a wireless communication apparatus that guarantees portability and mobility and may include any kind of handheld-based wireless communication apparatus such as a terminal, a smartphone, and a tablet PC that are based on communication such as International Mobile Telecommunication (IMT), Code Division Multiple Access (CDMA), W-Code Division Multiple Access (W-CDMA), and Long Term Evolution (LTE).

Hereinafter, example embodiments of the present disclosure will be fully described with reference to the accompanying drawings in such a way that those skilled in the art can easily carry out the example embodiments. The disclosure may, however, be embodied in many different forms and should not be construed as being limited to the example embodiments set forth herein.

Hereinafter, the example embodiments of the present disclosure will be described in detail with reference to the accompanying drawings.

In the example embodiments, detailed descriptions of the technical content which is well known and is not directly related to the example embodiments of the present disclosure are omitted to avoid obscuring the subject matter of the disclosure and to convey it more clearly.

For the same reason, some elements are exaggerated, omitted, or simplified in the accompanying drawings. Also, in practice, the elements may have sizes different from those shown in the drawings. The same reference numbers are used throughout the drawings to refer to the same or like parts.

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout.

It will be understood that each block of the flowcharts and/or block diagrams, and combinations of blocks in the flowcharts and/or block diagrams, can be implemented by computer program instructions. These computer program instructions may be provided to a processor of a general-purpose computer, a special purpose computer, or another programmable data processing apparatus, such that the instructions, which are executed via the processor of the computer or other programmable data processing apparatus, create a part for implementing the functions specified in a flowchart block(s). These computer program instructions may also be stored in a computer-accessible or computer-readable memory that can direct a computer or other programmable data processing apparatus to function in a particular manner, such that the instructions stored in the computer-accessible or computer-readable memory can also produce articles of manufacture embedding instruction means which implement the functions specified in the flowchart block(s). The computer program instructions may also be loaded onto a computer or another programmable data processing apparatus to cause a series of operations to be performed on the computer or another programmable data processing apparatus to produce a computer-implemented process, such that the instructions, which are executed on the computer and other programmable data processing apparatus, can also provide operations for implementing the functions specified in the flowchart block(s).

Also, each block described herein may indicate a portion of a module, segment, or code including one or more executable instructions to execute a specific logical function(s). Moreover, it should be noted that the functions of the blocks may be performed in a different order in several modifications. For example, two successive blocks may be performed substantially at the same time, or they may be performed in reverse order according to their functions.

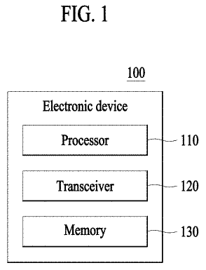

FIG. 1 is a block diagram showing elements of an electronic device according to various example embodiments of the present disclosure.

Referring to FIG. 1, the internal elements of the electronic device 100 are not limited to the shown elements. The electronic device 100 may include at least one of a processor 110, a transceiver 120, and a memory 130.

The processor 110 may process a series of operations for performing an information provision method according to various example embodiments of the present disclosure. The processor 110 controls the other elements of the electronic device 100.

Functionally, the transceiver 120 may transmit information stored in the memory 130 of the electronic device 100 or information processed by the processor 110 to another device or may receive information transmitted from another device to the electronic device 100.

The memory 130 is a data structure implemented in a predetermined storage space of the electronic device 100, and functions such as storing, searching for, deleting, editing, or adding data may be freely performed therein. For example, the memory 130 may include fields or elements for processing functions such as storing, searching for, deleting, editing, or adding data. The memory 130 may store data related to the electronic device 100 performing an information provision method. For example, the memory 130 may store instructions or data for an execution operation of the processor 110.

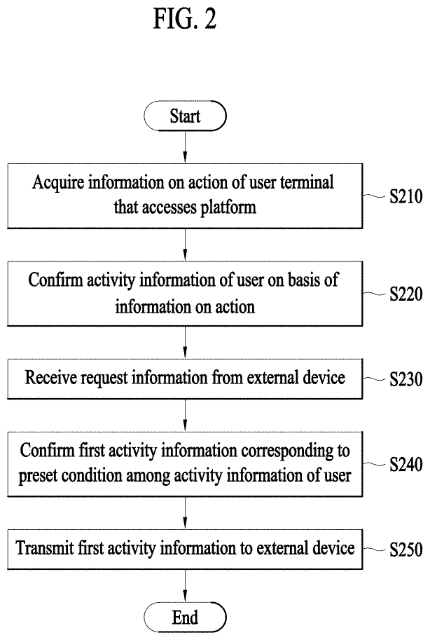

FIG. 2 is a schematic flowchart of an information provision method according to various example embodiments of the present disclosure.

Referring to FIG. 2, an electronic device (e.g., the electronic device 100 of FIG. 1) may provide necessary information to an external device. The electronic device may confirm information requested by the external device among user activity information generated in a platform under management and transmit the information to the external device.

In operation S210, the electronic device may acquire information on actions of at least one user terminal that accesses the platform under management. The platform may include an e-commerce platform being managed through an electronic device and may also include an electronic commerce platform. The user terminal is not particularly limited as long as it can access a platform being managed by the electronic device, and may include a mobile device (e.g., a smartphone), a computer, or the like. A user may access the platform through an application or software that is installed on the user terminal or that is installed on a cloud and available for use. The electronic device may confirm a route along which the user has accessed the platform through the user terminal. In this case, the electronic device may check through which user terminal the user has accessed the platform. The electronic device may acquire information on an action performed by the user through the user terminal. Here, the action of the user terminal may include all kinds of actions that the user performs after accessing the platform. For example, the action of the user terminal may include a click in the platform, an access route to the platform (e.g., access after clicking an advertisement), a purchase in the platform, a click on an advertisement in the platform, creation of a wish list in the platform, a page view in the platform, sign up for membership in the platform, and the like. The above actions of the user terminal are only examples, and the present disclosure is not limited thereto. The actions of the user terminal may include all kinds of actions that the user may perform through the terminal in the platform.

In operation S220, the electronic device may confirm activity information of at least one user on the basis of the information on actions of the user terminal. The electronic device may set the activity information of the user. For example, the electronic device may set at least some of the actions performed in the platform through the user terminal as the activity information of the user. The electronic device may set an action of clicking on an advertisement in the platform as the activity information of the user. The activity information of the user may include an action of the user terminal to be confirmed by the electronic device. For example, the activity information of the user may be included in the information on actions of the user terminal. The electronic device may confirm the activity information of the user through at least one of identification information of at least one user terminal and individually unique information of at least one user in the platform. Here, the identification information of the user terminal may include identification information, a serial number, or the like of a mobile device or a computer. Also, the individually unique information of the user in the platform may include an ID for each user in the platform or unique information given to individual users in the platform. The activity information of the user that has been achieved may be vast. The electronic device may collect activity information of at least one user which is achieved in the platform in real time and may transmit the collected activity information to at least one external device that manages another platform. The external device may request activity information of at least one user generated in the platform being managed by the electronic device, and the activity information provided to the external device may include information that matches request information including a preset condition reflecting requests from the external device. The external device may use the provided activity information to perform advertising, perform marketing, and provide user targeting information in another platform, which is managed by the external device.

In operation S230, the electronic device may receive request information including a preset condition from at least one external device. The electronic device may receive information requested by the external device among user activity information generated in the platform. For example, the information requested by the external device may include activity information of a user who clicks on an item being advertised in another platform, which is managed by the external device, among the user activity information, and accesses the platform being managed by the electronic device. In the following description, the information requested by the external device may be used interchangeably with the request information. For example, the request information may be included in the user activity information. The preset condition may include at least one of an advertisement category condition of at least one external device, an item price setting condition of at least one external device, a condition in which activity information of at least one user is generated by the user accessing the platform in response to an input to an advertisement area of another platform, and a condition in which address information for accessing the platform includes predetermined information. The preset condition may be included in request information to be collected by the external device and may include a condition that is set for user activity information to be collected by the external device.

In operation S240, the electronic device may confirm at least one piece of first activity information that matches the preset condition among the activity information of the at least one user. The electronic device may confirm activity information that matches request information received from the external device as the first activity information. In the following description, activity information that matches the request information among the user activity information, activity information corresponding to the preset condition among the user activity information, or information to be collected by the external device among the user activity information may be used interchangeably with the first activity information.

In operation S250, the electronic device may transmit at least one piece of first activity information to at least one external device. The electronic device may receive request information from at least one external device, and the request information may be different for each individual external device. Thus, the electronic device may classify the request information as first request information or second request information and transmit individual activity information corresponding to individual request information to a corresponding individual external device.

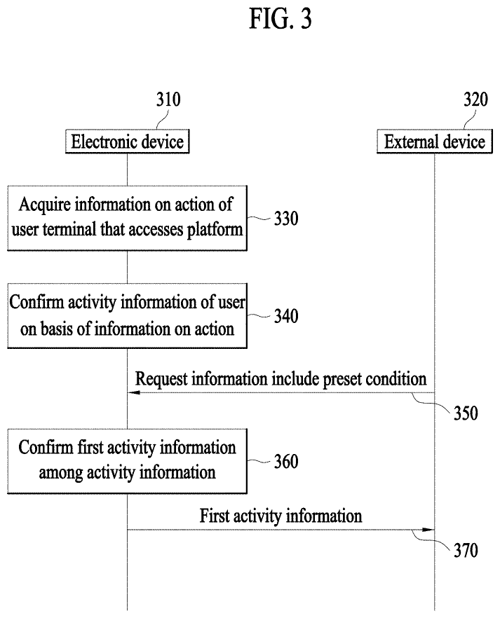

FIG. 3 is a flowchart related to the provision of information between an electronic device and an external device according to various example embodiments of the present disclosure.

Referring to FIG. 3, an electronic device 310 (e.g., the electronic device 100 of FIG. 1) may transmit and receive information to and from an external device 320. When the information collected and confirmed in the platform under management matches information requested from another platform, which is managed by the external device 320, the electronic device 310 may transmit the matching information (e.g., the first activity information) to the external device 320.

According to various example embodiments, the electronic device 310 may acquire information on actions of a user terminal that accesses the platform in operation 330. The electronic device 310 may confirm a route along which the user has accessed the platform through the user terminal. In this case, the electronic device 310 may check through which user terminal the user has accessed the platform. The electronic device 310 may acquire information on an action performed by the user through the user terminal. Here, the action of the user terminal may include all kinds of actions that the user performs after accessing the platform. For example, the action of the user terminal may include a click in the platform, an access route to the platform (e.g., access after clicking an advertisement), a purchase in the platform, a click on an advertisement in the platform, creation of a wish list in the platform, a page view in the platform, sign up for membership in the platform, and the like. The above actions of the user terminal are only examples, and the present disclosure is not limited thereto. The actions of the user terminal may include all kinds of actions that the user may perform through the terminal in the platform.

According to various example embodiments, the electronic device 310 may confirm the user activity information in the platform on the basis of the information on the actions of the user terminal in operation 340. The electronic device 310 may classify the user activity information in the platform under management into first information, second information, and third information. For example, the first information may include information on a page view in the platform, the second information may include information on an order in the platform, and the third information may include information related to a search in the platform. For example, the first information may include at least one of item page view information, home screen view information, category page view information, in-page advertisement inflow information, and page sharing information of a user in the platform. As another example, the second information may include at least one of shopping cart information, order completion information, order cancellation information, and item review information of a user in the platform. As another example, the third information may include at least one of item search information, category search information, and keyword search information of a user in the platform.

According to various example embodiments, the electronic device 310 may receive request information including a preset condition from at least one external device 320 in operation 350. The electronic device 310 may receive request information through a transceiver (e.g., the transceiver 120 of FIG. 1). The electronic device 310 may receive information requested by the external device 320 among the user activity information generated in the platform. For example, the information requested by the external device 320 may include activity information of a user who clicks on an item being advertised in another platform, which is managed by the external device 320, among the user activity information, and accesses the platform being managed by the electronic device 310. The preset condition may be included in request information to be collected by the external device 320 and may include a condition that is set for user activity information to be collected by the external device 320.

According to various example embodiments, the electronic device 310 may confirm at least one piece of first activity information that matches the preset condition among the activity information of at least one user in operation 360. The electronic device 310 may confirm activity information that matches request information received from the external device 320 as the first activity information. For example, company “A,” which is one of the at least one external device 320, may transmit, to the electronic device 310, a preset condition including request information regarding whether to click on an advertisement on an item being advertised in the platform of company “A” and purchase the item of the advertisement in the platform of the electronic device 310. The electronic device 310 may confirm user activity information corresponding to the request information of company “A” as the first activity information. As another example, company “B,” which is one of the at least one external device 320, may transmit, to the electronic device 310, a preset condition including request information regarding whether to share a purchase page for an item being advertised in the platform of company “B.” The electronic device 310 may confirm user activity information corresponding to the request information of company “B” as the first activity information. As another example, company “C,” which is one of the at least one external device 320, may transmit, to the electronic device 310, a preset condition including request information related to item purchase prices of users who are using the platform of company “C” by age group in the platform of the electronic device 310 in order to collect information related to purchase prices of the users. Such examples are only a part of the possible examples, and the present disclosure is not limited thereto.

According to various example embodiments, the electronic device 310 may transmit at least one piece of first activity information to the at least one external device 320 in operation 370. The electronic device may receive request information from at least one external device, and the request information may be different for each individual external device. Thus, the electronic device may classify the request information as first request information or second request information and transmit individual activity information corresponding to individual request information to a corresponding individual external device.

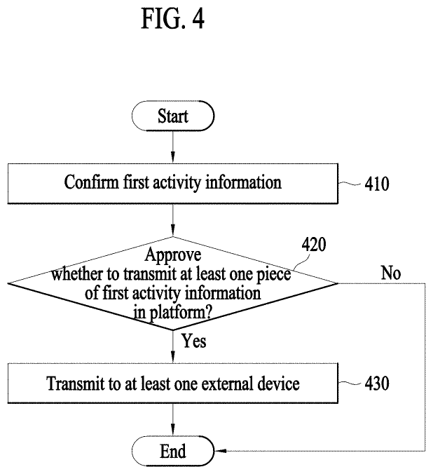

FIG. 4 is a flowchart illustrating approval related to the provision of information from an electronic device to an external device according to various example embodiments of the present disclosure.

Referring to FIG. 4, an electronic device (e.g., the electronic device 100 of FIG. 1 or the electronic device 310 of FIG. 3) may transmit first activity information confirmed in the platform under management to an external device (e.g., the external device 320 of FIG. 3). When transmitting the first activity information to the external device, the electronic device may be configured to perform an approval process regarding whether to transmit the first activity information.

The electronic device may confirm the first activity information in operation 410. The electronic device may confirm activity information that matches request information received from at least one external device as the first activity information. The first activity information may include activity information generated by at least one user terminal accessing the platform being managed by the electronic apparatus in response to an input to an advertisement area of another platform. Here, the user terminal applying an input to the advertisement area of the other platform may include a user clicking on an advertisement posting area of the other platform through a user terminal so that the user is redirected and thus accesses or is introduced to the platform of the electronic apparatus. The first activity information may include information in which address information provided when the at least one user terminal accesses the platform corresponds to a serial number with a predetermined number of digits. Here, the address information provided when the user terminal accesses the platform may include a uniform resource locator (URL), and a serial number with a predetermined number of digits included in the URL may have a separate parameter for each digit, which may be confirmed by the electronic device.

The electronic device may determine whether to approve or reject transmission of at least one piece of first activity information in the platform under management in operation 420. For example, the electronic device may determine whether to transmit first activity information confirmed in the platform under management to an external device. For example, the electronic device may check whether the confirmed first activity information corresponds to information requested by at least one external device and may determine whether to transmit the first activity information in operation 420. When company “A,” which is one of the at least one external device, changes the request information, the electronic device should transmit the first activity information according to the changed request information. For example, as in operation 420, the electronic device may check whether the first activity information is first activity information corresponding to the request information received from the at least one external device and then determine whether to transmit the first activity information. The electronic device may transmit the first activity information to the at least one external device in operation 430.

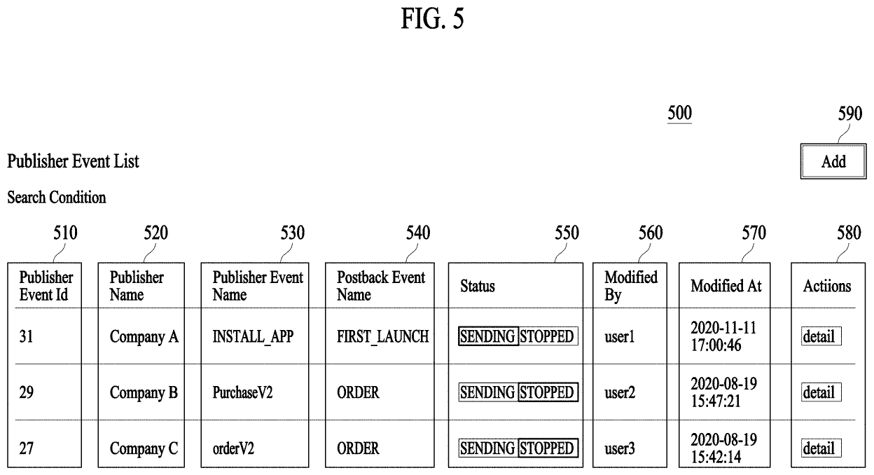

FIG. 5 is an exemplary diagram related to information stored in an electronic device according to various example embodiments of the present disclosure.

Referring to FIG. 5, an electronic device (e.g., the electronic device 100 of FIG. 1 or the electronic device 310 of FIG. 3) may store a list of request information received from at least one external device (e.g., the external device 320 of FIG. 3). The list may include at least one of name information about activity information of at least one user, time information related to first activity information, and detailed information of first activity information. The list shown in FIG. 5 is only an example, and the present disclosure is not limited thereto.

According to various example embodiments, the electronic device may store a list 500 of request information received from at least one external device in a table form. The request information list 500 may include ID information 510 of the external device, name information 520 of the external device, request information 530 of the external device, name information 540 of the user activity information, transmission status information 550 of the first activity information, developer name information 560 for confirming the first activity information, time information 570 related to the first activity information, and detailed information 580 of the first activity information. The electronic device may receive changed request information from at least one external device, and the electronic device may transmit second activity information (e.g., first activity information corresponding to the changed request information) to at least one external device according to the received changed request information. Here, when the request information is changed, the electronic device may change the request information using an input for addition 590 through a user interface (UI) or the like which is provided along with the stored list 500 of the request information

The electronic apparatus may confirm at least one piece of first activity information transmitted to at least one external device according to the corresponding external device on the basis of the stored request information list 500. For example, the electronic device may confirm the name information 520 of the external device, the request information 530 of the external device, the name information 540 for the user activity information, and the transmission status information 550 of the first activity information to confirm the first activity information according to the corresponding external device.

The electronic device may determine whether to approve or reject transmission of at least one piece of first activity information in the platform under management on the basis of the stored request information list 500. For example, the electronic device may check whether the confirmed first activity information corresponds to information requested by at least one external device and may determine whether to transmit the first activity information. When company “A,” which is one of the at least one external device, changes the request information, the electronic device should transmit the first activity information according to the changed request information. The electronic device may check whether the first activity information is first activity information corresponding to the request information received from the at least one external device and determine whether to transmit the first activity information. When transmitting the first activity information corresponding to the request information to the external device, the electronic device may set and store the transmission status information 550 of the first activity information as “SENDING” as shown in FIG. 5. In this way, the electronic device may transmit the first activity information to the external device in real time or according to a preset period.

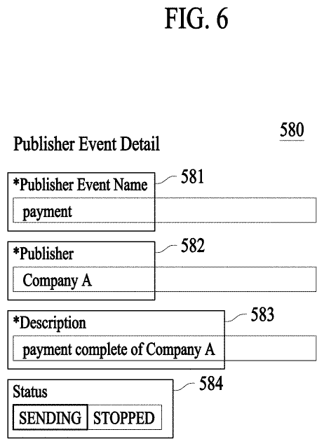

FIG. 6 is an exemplary diagram related to detailed information transmitted to an external device among information stored in an electronic device according to various example embodiments of the present disclosure.

FIG. 6 corresponds to an example related to detailed information 580 of the first activity information shown in FIG. 5. For example, the detailed information 580 of the first activity information may include at least one of request information 581 of the external device (e.g., the request information 530 of the external device of FIG. 5), name information 582 of the external device (e.g., the name information 520 of the external device of FIG. 5), description information 583 for request information of the external device, and transmission status information 584 of the first activity information (e.g., the transmission status information 550 of the first activity information of FIG. 5).

The electronic device may configure a separate interface capable of confirming the detailed information 580 of the first activity information, and this can be confirmed by a developer or an administrator of the platform under management through the electronic device. For example, the electronic device may store a request information list (e.g., the request information list 500 of FIG. 5) and provide the request information list to a developer or administrator of the platform, and FIGS. 5 and 6 may correspond to examples of an interface for providing information. As another example, the electronic device may transmit the detailed information 580 of the first activity information to an external device that has requested the first activity information. The external device may check whether the first activity information being received matches the request information. By receiving the first activity information, the external device may utilize the first activity information in a business area of another platform, which is managed by the external device. The electronic device may transmit information requested by an individual external device to at least one external device. Upon receiving the request information, the individual external device may effectively operate by using the first activity information in the business area of the other platform under management.

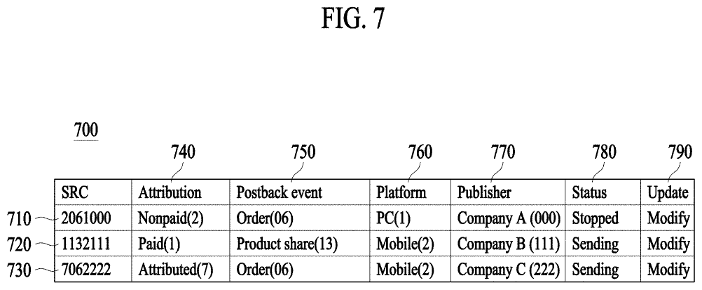

FIG. 7 is an exemplary diagram related to information provided from an electronic device to an external device according to various example embodiments of the present disclosure.

Referring to FIG. 7, an electronic device (e.g., the electronic device 100 of FIG. 1 or the electronic device 310 of FIG. 3) may provide first activity information-related information 700 to an external device (e.g., the external device 320 of FIG. 3). The first activity information-related information 700 may include information transmitted to at least one external device, which may vary depending on transmission status information 780 of the first activity information (e.g., the transmission status information 550 of the first activity information of FIG. 5 or the transmission status information 584 of the first activity information of FIG. 6). As an example, when the transmission status information 780 of the first activity information is “Stopped,” the electronic device may not transmit first activity information whose transmission has been stopped to the external device among the first activity information-related information 700. As another example, when the transmission status information 780 of the first activity information is “Sending,” the electronic device may transmit first activity information which is being transmitted to the external device among the first activity information-related information 700.

The electronic device may confirm at least one piece of first activity information transmitted to at least one external device according to the corresponding external device. Also, the electronic device may store the information shown in FIG. 5 or 7, i.e., information on or a list of the first activity information transmitted to the external device in the form of a table. The first activity information may include information in which address information provided when the at least one user terminal accesses the platform corresponds to a serial number with a predetermined number of digits.

The first activity information-related information 700 may include management information 740, request information 750, information 760 on a user terminal, and name information 770 of an external device and may assign numbers to the pieces of information according to each type. As an example, for the management information 740, the number “1” may be assigned when a fee is paid to an external device (e.g., Paid), the number “2” may be assigned when no fee is paid (e.g., Nonpaid), and the number “7” may be assigned when fees are managed but it is not known whether a fee has been paid.

For the request information 750, the number “06” may be assigned in a case related to an order (e.g., Order), and the number “13” may be assigned in a case of sharing an item page (e.g., Product share). For example, the number “2” may be assigned to the management information 740 because no fee is paid to an external device, the number “06” may be assigned to the request information 750 of the external device because the request is related to an order, the number “1” may be assigned to the information 760 on a user terminal that accesses a platform when the user terminal is a computer, and the number “000” may be assigned when the name information 770 of the external device is company “A.” In this case, a serial number “2061000” (710) may be generated. In this way, the electronic device may map first activity information according to request information received from an individual external device and manage the first activity information through a serial number. The electronic device may confirm the first activity information by including such a serial number in address information provided to a user terminal that accesses a platform under management.

An information provision method of an electronic device according to various example embodiments of the present disclosure may include acquiring information on an action of at least one user terminal that accesses a platform, confirming activity information of at least one user on the basis of the information on the action, receiving request information including a preset condition from at least one external device, confirming at least one piece of first activity information corresponding to the preset condition among the activity information of the at least one user, and transmitting the at least one piece of first activity information to the at least one external device.

In the information provision method of the electronic device according to various example embodiments of the present disclosure, the platform may be managed by the electronic device, and the at least one external device may manage a platform different from the platform.

In the information provision method of the electronic device according to various example embodiments of the present disclosure, the confirming of activity information of at least one user may include confirming identification information of the at least one user through at least one of individually unique information of the at least one user in the platform and identification information of the at least one user terminal.

In the information provision method of the electronic device according to various example embodiments of the present disclosure, the activity information of the at least one user may include first information on a page view in the platform, second information on an order in the platform, and third information related to a search in the platform.

In the information provision method of the electronic device according to various example embodiments of the present disclosure, the first information may include at least one of item page view information, home screen view information, category page view information, in-page advertisement inflow information, and page sharing information of the user, the second information may include at least one of shopping cart information, order completion information, order cancellation information, and item review information of the user, and the third information may include at least one of item search information, category search information, and keyword search information of the user.

The information provision method of the electronic device according to various example embodiments of the present disclosure may include at least one of an advertisement category condition of the at least one external device, an item price setting condition of the at least one external device, a condition in which the activity information of the at least one user is generated by the at least one user terminal accessing the platform in response to an input to an advertisement area of another platform, and a condition in which address information for accessing the platform includes predetermined information.

The information provision method of the electronic device according to various example embodiments of the present disclosure may further include storing a list of request information of the at least one external device. The list may include at least one of name information on the activity information of the at least one user, time information related to the first activity information, and detailed information of the first activity information.

The information provision method of the electronic device according to various example embodiments of the present disclosure may further include receiving changed request information from the at least one external device and providing second activity information to the at least one external device according to the received changed request information.

The information provision method of the electronic device according to various example embodiments of the present disclosure may further include approving whether to transmit the at least one piece of first activity information in the platform. The transmitting may include transmitting the at least one piece of first activity information to the at least one external device in response to being approved.

The information provision method of the electronic device according to various example embodiments of the present disclosure may further include confirming the at least one piece of first activity information transmitted to the at least one external device according to each external device and storing a list for the at least one piece of first activity information transmitted to the at least one external device.

In the information provision method of the electronic device according to various example embodiments of the present disclosure, the activity information of the at least one user may include an action related to an item for which the at least one user terminal corresponds to the item price setting condition of the at least one external device.

In the information provision method of the electronic device according to various example embodiments of the present disclosure, the first activity information may include activity information generated by the at least one user terminal accessing the platform in response to the input to the advertisement area of the other platform.

In the information provision method of the electronic device according to various example embodiments of the present disclosure, the first activity information may include information in which address information provided when the at least one user terminal accesses the platform corresponds to a serial number with a predetermined number of digits.

An electronic device for providing information according to various example embodiments of the present disclosure may include a processor configured to acquire information on an action of at least one user terminal that accesses a platform, confirm activity information of at least one user on the basis of the information on the action, receive request information including a preset condition from at least one external device, confirm at least one piece of first activity information corresponding to the preset condition among the activity information of the at least one user, and transmit the at least one piece of first activity information to the at least one external device.

A non-transitory computer-readable storage medium according to various example embodiments of the present disclosure may include a medium configured to store computer-readable instructions. When executed by a processor, the computer-readable instructions may enable the processor to perform an information provision method including acquiring information on an action of at least one user terminal that accesses a platform, confirming activity information of at least one user on the basis of the information on the action, receiving request information including a preset condition from at least one external device, confirming at least one piece of first activity information corresponding to the preset condition among the activity information of the at least one user, and transmitting the at least one piece of first activity information to the at least one external device.

Meanwhile, in the present specification and the accompanying drawings, example embodiments of the present disclosure have been disclosed, and although specific terms are used, these terms are only used in a general sense to easily describe the technical content of the present disclosure and to aid understanding of the present disclosure and do not limit the scope of the present disclosure. It is obvious to those skilled in the art that in addition to the example embodiments disclosed herein, various modifications may be made without departing from the technical spirit of the present disclosure.

According to the above-described example embodiments, an electronic apparatus or a terminal may include a processor, a memory configured to store and execute program data, a permanent storage such as a disk drive, a communication port configured to communicate with an external apparatus, a user interface device such as a touch panel, a key, and a button, and the like. Methods implemented using software modules or algorithms may be stored on a computer-readable recording medium as computer-readable code or program instructions executable on the processor. Here, the computer-readable recording medium may include a magnetic storage medium (e.g., ROM, RAM, floppy disk, hard disk, etc.), an optical reading medium (e.g., CD-ROM, digital versatile disc (DVD), etc.), and the like. The computer-readable recording medium may be distributed over network-coupled computer systems so that the computer-readable code is stored and executed in a distributed fashion. The medium is readable by a computer, stored in a memory, and executed on a processor.

The example embodiments may be described in terms of functional block components and various processing operations. The functional blocks may be implemented by various numbers of hardware and/or software components configured to perform specific functions. For example, the example embodiments may employ integrated circuit elements, such as a memory, a processing circuit, a logic circuit, and a look-up table, for executing various functions under the control of one or more microprocessors or other control apparatuses. Similar to the elements being executable with software programming or software elements, the example embodiments may be implemented with a programming or scripting language, such as C, C++, Java, and an assembler, including various algorithms implemented with a combination of data structures, processes, routines or other programming elements. Functional aspects may be implemented with an algorithm executed by one or more processors. Furthermore, the example embodiments may employ any number of related art techniques for electronics configuration, signal processing, data processing, and the like. The terms “mechanism,” “element,” “means,” and “configuration” may be widely used and are not limited to mechanical and physical configurations. The terms may include a meaning of a series of routines of software in association with a processor.

The above-described example embodiments are only examples, and other example embodiments may be implemented within the scope of the claims, which will be described below.

1. A method of providing information by an electronic device, the method comprising:
acquiring information on an action of at least one user terminal that accesses a platform;
confirming activity information of at least one user on the basis of the information on the action;
receiving request information including a preset condition from at least one external device, wherein the request information comprises at least one of: management information associated with the at least one external device, information associated with a requested action, device type information associated with a user terminal that accesses the platform, and name information of the external device;
generating a serial number corresponding to the request information by combining at least one of: a first serial number assigned based on the management information, a second serial number assigned based on the information associated with the requested action, a third serial number assigned based on the device type information, and a fourth serial number assigned based on the name information;
confirming at least one piece of first activity information corresponding to the preset condition among the activity information of the at least one user by comparing the serial number corresponding to the request information with address information provided to the at least one user terminal for accessing the platform; and
transmitting the at least one piece of first activity information to the at least one external device.

2. The method of claim 1, wherein the platform is managed by the electronic device, and
the at least one external device manages a platform different from the platform.

3. The method of claim 1, wherein the confirming at least one piece of first activity information comprises confirming identification information of the at least one user through at least one of individually unique information of the at least one user in the platform and identification information of the at least one user terminal.

4. The method of claim 1, wherein the activity information of the at least one user includes first information on a page view in the platform, second information on an order in the platform, and third information related to a search in the platform.

5. The method of claim 4, wherein the first information includes at least one of item page view information, home screen view information, category page view information, in-page advertisement inflow information, and page sharing information of the user,
the second information includes at least one of shopping cart information, order completion information, order cancellation information, and item review information of the user, and
the third information includes at least one of item search information, category search information, and keyword search information of the user.

6. The method of claim 1, wherein the preset condition includes at least one of:
an advertisement category condition of the at least one external device,
an item price setting condition of the at least one external device,
a condition in which the activity information of the at least one user is generated by the at least one user terminal accessing the platform in response to an input to an advertisement area of another platform, and
a condition in which address information for accessing the platform includes predetermined information.

7. The method of claim 1, further comprising:
storing a list of request information of the at least one external device,
wherein the list includes at least one of name information on the activity information of the at least one user, time information related to the first activity information, and detailed information of the first activity information.

8. The method of claim 1, further comprising:
receiving changed request information from the at least one external device; and
providing second activity information to the at least one external device according to the received changed request information.

9. The method of claim 1, further comprising:
approving whether to transmit the at least one piece of first activity information in the platform,
wherein the transmitting comprises transmitting the at least one piece of first activity information to the at least one external device in response to being approved.

10. The method of claim 1, further comprising:
confirming the at least one piece of first activity information transmitted to the at least one external device according to each external device; and
storing a list for the at least one piece of first activity information transmitted to the at least one external device.

11. The method of claim 6, wherein the activity information of the at least one user includes an action related to an item for which the at least one user terminal corresponds to the item price setting condition of the at least one external device.

12. The method of claim 6, wherein the first activity information includes activity information generated by the at least one user terminal accessing the platform in response to the input to the advertisement area of the other platform.

13. The method of claim 6, wherein the first activity information includes information in which the information on the address provided when the at least one user terminal accesses the platform corresponds to a serial number with a predetermined number of digits.

14. An electronic device for providing information, the electronic device comprising:
a processor,
wherein the processor is configured to:
acquire information on an action of at least one user terminal that accesses a platform;
confirm activity information of at least one user on the basis of the information on the action;
receive request information including a preset condition from at least one external device, wherein the request information comprises at least one of: management information associated with the at least one external device, information associated with a requested action, device type information associated with a user terminal that accesses the platform, and name information of the external device;
generate a serial number corresponding to the request information by combining at least one of a first serial number assigned based on the management information, a second serial number assigned based on the information associated with the requested action, a third serial number assigned based on the device type information, and a fourth serial number assigned based on the name information;
confirm at least one piece of first activity information corresponding to the preset condition among the activity information of the at least one user by comparing the serial number corresponding to the request information with address information provided to the at least one user terminal for accessing the platform; and
transmit the at least one piece of first activity information to the at least one external device.

15. A non-transitory computer-readable storage medium comprising a medium configured to store computer-readable instructions,
wherein when the computer-readable instructions are executed by a processor, the processor performs a method of providing information, the method comprising:
acquiring information on an action of at least one user terminal that accesses a platform;
confirming activity information of at least one user on the basis of the information on the action, wherein the request information comprises at least one of: management information associated with the at least one external device, information associated with a requested action, device type information associated with a user terminal that accesses the platform, and name information of the external device;
generating a serial number corresponding to the request information by combining at least one of a first serial number assigned based on the management information, a second serial number assigned based on the information associated with the requested action, a third serial number assigned based on the device type information, and a fourth serial number assigned based on the name information;
receiving request information including a preset condition from at least one external device;
confirming at least one piece of first activity information corresponding to the preset condition among the activity information of the at least one user by comparing the serial number corresponding to the request information with address information provided to the at least one user terminal for accessing the platform; and
transmitting the at least one piece of first activity information to the at least one external device.
